(19) United States
(12) Patent Application Publication
(10) Pub. No.: US 2026/0305538 A1
(43) Pub. Date: Oct. 8, 2026

(54) CULTIVATION DEVICE

(71) Applicant: CJ CHEILJEDANG CORPORATION, Seoul (KR)

(72) Inventors: Chang Hyeong LEE, Seoul (KR); Seok Young PARK, Seoul (KR)

(73) Assignee: CJ CHEILJEDANG CORPORATION, Seoul (KR)

(21) Appl. No.: 19/479,220

(22) PCT Filed: Apr. 26, 2024
(86) PCT No.: PCT/KR2024/005683

§ 371 Date: Oct. 27, 2025

(30) Foreign Application Priority Data
Apr. 27, 2023 (KR) 10-2023-0055702

(51) Int. Cl. A01G 9/02

(52) U.S. Cl. CPC A01G 9/028

(57) ABSTRACT

A cultivation apparatus according to an embodiment of the present disclosure may include a cultivation plate provided with a plurality of cultivation holes in which plants are planted, a cultivation chamber configured to accommodate a nutrient solution to be supplied to the plants, the cultivation chamber including a cultivation opening in which the cultivation plate is positioned, and a guide portion formed on the cultivation chamber so that the cultivation plate is seated on the guide portion to align a position of the cultivation plate.

### CROSS-REFERENCE TO RELATED APPLICATION

The present application claims priority to and the benefit of Korean Patent Application No. 10-2023-0055702 filed on Apr. 27, 2023, and the entire contents disclosed in the specification and drawings of the present application are incorporated herein by reference.

### TECHNICAL FIELD

The present disclosure relates to a cultivation apparatus.

### BACKGROUND ART

A soilless cultivation method, which cultures plants by using a mineral nutrient solution, is used as a method of growing plants. A plant growth apparatus using the corresponding method generally includes a cultivation system, a light system, a nutrient solution system, an environment control system, and an air conditioning system.

In the automated plant growth apparatus, a mechanized device may be used during a process of harvesting and/or transplanting plants by transferring a cultivation plate on which the plants grow. In case that the cultivation plate and a cultivation tank are not appropriately aligned when a robot handles the cultivation plate, errors, such as damage to the cultivation plate and abnormality of the robot in recognizing a structure, may occur. Therefore, there is a need for a cultivation apparatus capable of optimizing the alignment between the cultivation tank and the cultivation plate.

The above-mentioned background art is technical information that the inventors have retained to derive the present disclosure or have obtained in the course of deriving the present disclosure, and cannot be thus said to be technical information publicly known to the public before filing the present application.

### DISCLOSURE

### Technical Problem

The present disclosure has been made in an effort to solve the above-mentioned problem, and an object of an embodiment of the present disclosure is to provide a cultivation apparatus capable of aligning a position of a cultivation plate seated on a cultivation chamber.

### Technical Solution

A cultivation apparatus according to an embodiment of the present disclosure may include a cultivation plate provided with a plurality of cultivation holes in which plants are planted, a cultivation chamber configured to accommodate a nutrient solution to be supplied to the plants, the cultivation chamber including a cultivation opening in which the cultivation plate is positioned, and a guide portion formed on the cultivation chamber so that the cultivation plate is seated on the guide portion to align a position of the cultivation plate.

The guide portion may include concave-convex elements on which the cultivation plate is seated.

The cultivation chamber may further include: a chamber body; and a support frame protruding from an inner surface of the chamber body and configured to be in contact with the cultivation plate and support the cultivation plate from the inside thereof.

The cultivation plate may include: a plate body having the cultivation holes; and coupling elements formed on a bottom surface of the plate body and configured to be seated on the concave-convex elements.

The concave-convex elements include: a first concave-convex element provided on the support frame so that a central portion of the cultivation plate is seated on the first concave-convex element; and second concave-convex elements provided on the chamber body so that two opposite portions of the cultivation plate are seated on the second concave-convex elements.

The concave-convex element may be provided in the form of a groove that engages with the coupling element of the cultivation plate.

The coupling element may include a wheel placed in the groove so that the plate body is movable relative to the cultivation chamber.

The concave-convex element may include a guide protrusion protruding from the cultivation chamber, and the coupling element may include an accommodation groove into which the guide protrusion is inserted.

The cultivation apparatus may further include: a service opening defined by the cultivation plate and the cultivation chamber.

The cultivation apparatus according to the embodiment of the present disclosure may further include: a first service groove recessed from an end of the cultivation plate; and a second service groove recessed from an upper end of the cultivation chamber at which the cultivation opening is formed, the second service groove being configured to define the service opening together with the first service groove when the cultivation plate covers the cultivation opening.

The cultivation apparatus according to the embodiment of the present disclosure may further include: a discharge part provided in the cultivation chamber and configured to discharge the nutrient solution accommodated in the cultivation chamber.

The discharge part may include a first discharge hole formed through a bottom surface of the cultivation chamber.

The discharge part may further include a second discharge hole formed through a lateral surface of the cultivation chamber adjacent to the bottom surface.

The cultivation apparatus according to the embodiment of the present disclosure may further include: a control plate separably coupled to the bottom surface of the cultivation chamber and configured to adjust a level of the nutrient solution.

The control plate may be disposed between the first discharge hole and the second discharge hole.

### Advantageous Effects

In the cultivation apparatus according to the embodiment of the present disclosure, the position of the cultivation plate seated on the cultivation chamber may be aligned.

In addition, the technical effects may include effects readily predictable by those skilled in the art from the configurations according to the embodiment of the present disclosure.

### DESCRIPTION OF DRAWINGS

FIG. 1 is an exploded perspective view illustrating a cultivation apparatus according to an embodiment of the present disclosure.

FIG. 2 is a coupled perspective view illustrating the cultivation apparatus according to the embodiment of the present disclosure.

FIG. 3 is a coupled perspective view illustrating the cultivation apparatus according to the embodiment of the present disclosure that is provided with a plurality of cultivation plates.

FIG. 4 is a perspective view illustrating the cultivation chamber according to the embodiment of the present disclosure.

FIG. 5 is a perspective view illustrating a bottom surface of the cultivation plate according to the embodiment of the present disclosure.

FIGS. 6 and 7 are schematic views illustrating a shape in which the cultivation plate of the cultivation apparatus according to the embodiment of the present disclosure is seated on a cultivation chamber.

FIGS. 8 to 10 are views illustrating a drainage system of the cultivation apparatus according to the embodiment of the present disclosure.

### MODE FOR INVENTION

Hereinafter, exemplary embodiments of the present disclosure will be described in detail with reference to the accompanying drawings so that those with ordinary skill in the art to which the present disclosure pertains may easily carry out the embodiments. The following description is one of several aspects of the embodiments. In the description of the present disclosure, a specific description of a function or configuration already publicly known will be omitted in order to clarify the subject matter of the present disclosure.

In assigning reference numerals to constituent elements of the respective drawings in the present specification, the same or similar constituent elements will be designated by the same or similar reference numerals throughout the specification. The constituent element, which has the same common function as the constituent element included in any one embodiment, will be described by using the same name in other embodiments. Terms or words used in the specification and the claims should not be interpreted as being limited to a general or dictionary meaning and should be interpreted as a meaning and a concept which conform to the technical spirit of the present disclosure based on a principle that an inventor can appropriately define a concept of a term in order to describe his/her own invention by the best method.

In addition, the present disclosure is not limited to the embodiments and may be variously modified and altered from the disclosure by those skilled in the art to which the present disclosure pertains. Accordingly, the spirit of the present disclosure should not be limited to the described embodiment, and all of the equivalents or equivalent modifications of the claims as well as the appended claims belong to the scope of the spirit of the present disclosure.

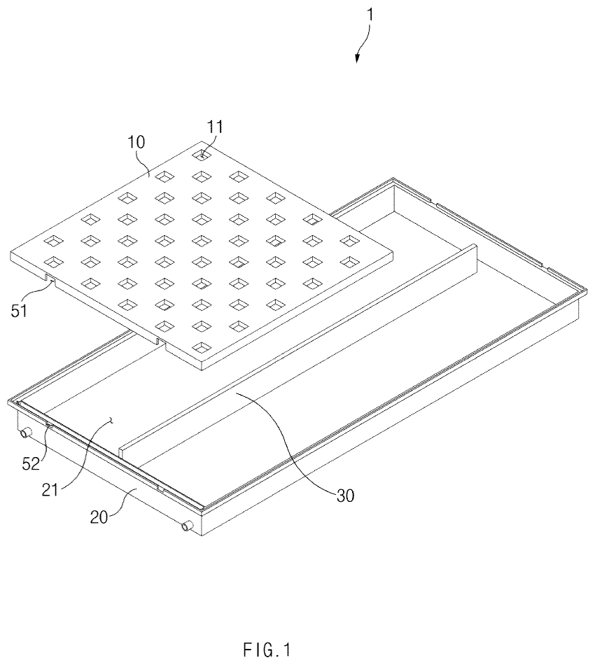

FIG. 1 is an exploded perspective view illustrating a cultivation apparatus 1 according to an embodiment of the present disclosure.

With reference to FIG. 1, the cultivation apparatus 1 according to the embodiment of the present disclosure may include a cultivation plate 10 and a cultivation chamber 20.

Plants may be planted in the cultivation plate 10. The cultivation plate 10 may be configured to allow a plurality of plants to be planted. The cultivation plate 10 may include cultivation holes 11 in which plants may be planted. A plurality of cultivation holes 11 may be formed in the cultivation plate 10. For example, the cultivation hole 11 may be provided in the form of a square opening. The cultivation holes 11 may be formed in the cultivation plate 10 and spaced apart from one another at preset intervals. The cultivation holes 11 may be formed in the cultivation plate and spaced apart from one another at equal intervals. For example, as illustrated in FIG. 1, the cultivation holes 11 may be disposed to be spaced apart from one another in a lattice shape. In this case, one cultivation hole 11 and another cultivation hole 11, which is adjacent to one cultivation hole 11, may be placed in a staggered manner and define one row in a diagonal direction. However, an arrangement pattern of the cultivation holes 11 may be variously modified, as necessary. Therefore, a size of the cultivation hole 11 and an interval between the cultivation holes 11 may be variously changed. Further, for example, the cultivation plate 10 may be formed in a square or rectangular plate shape. However, the present disclosure is not limited thereto.

The cultivation chamber 20 may be configured such that the cultivation plate 10 is seated on the cultivation chamber 20. A cultivation opening 21, in which the cultivation plate 10 is positioned, may be formed in the cultivation chamber 20. The cultivation plate 10 may be placed on the cultivation chamber 20 and cover the cultivation opening 21 of the cultivation chamber 20. A nutrient solution, which may be supplied to the plants planted in the cultivation plate 10, may be accommodated in an internal space of the cultivation chamber 20. The nutrient solution may be accommodated in the cultivation chamber 20 at a preset level from a bottom surface of the cultivation chamber 20. The cultivation chamber 20 may be formed in a shape extending in a longitudinal direction while having a preset width.

The cultivation chamber 20 may include a support frame 30. The support frame 30 may be provided in the cultivation chamber 20. The support frame 30 may be provided in the form of a plate that traverses the internal space of the cultivation chamber 20. The support frame 30 may support the cultivation plate 10 placed on the cultivation chamber 20 from the inside thereof. The support frame 30 may be in contact with a bottom surface of the cultivation plate 10 placed on the cultivation chamber 20 and support a load of the cultivation plate 10. The support frame 30 may be in contact with a central portion of the cultivation plate 10 and support the central portion of the cultivation plate 10. The support frame 30 may be formed to protrude from an inner surface of the cultivation chamber 20.

The cultivation apparatus 1 according to the embodiment of the present disclosure may include a first service groove 51 and a second service groove 52. Because the configuration including the first service groove 51 and the second service groove 52 is adopted, the cultivation apparatus 1 according to the embodiment of the present disclosure may have a service opening that an external device may reach in case that the cultivation plate 10 is seated on the cultivation chamber 20.

The first service groove 51 may be formed in the cultivation plate 10. The first service groove 51 may be recessed from an end of the cultivation plate 10. The first service groove 51 may be provided as a plurality of first service grooves 51 formed in the cultivation plate 10. The first service groove 51 may define a part of the service opening to be described below in the state in which the cultivation plate 10 is seated on the cultivation chamber 20.

The second service groove 52 may be formed in the cultivation chamber 20. The second service groove 52 may be recessed from an upper end of the cultivation chamber 20 at which the cultivation opening 21 is formed. The second service groove 52, together with the first service groove 51 of the cultivation plate 10, may define the service opening in case that the cultivation plate 10 is seated on the cultivation chamber 20.

The second service groove 52 may be formed at a position corresponding to the first service groove 51 formed in the cultivation plate 10 in case that the cultivation plate 10 is seated on the cultivation chamber 20.

For example, the plurality of first service grooves 51 and the second service grooves 52, which correspond to the plurality of first service grooves 51, may be formed at a longitudinal end of the cultivation plate 10 and a longitudinal end of the cultivation chamber 20. In this case, an external device (e.g., a robot arm) may be inserted in the longitudinal direction of the cultivation plate 10 and the cultivation chamber 20 and reach the inside of the cultivation chamber. As necessary, the first service groove 51 and the second service groove 52 may be formed at lateral ends of the cultivation plate 10 and the cultivation chamber 20 that are perpendicular to the longitudinal direction. In this case, a direction in which the external device reaches the cultivation chamber may correspond to the positions at which the first service groove 51 and the second service groove 52 are formed, and the external device may reach the cultivation chamber in the lateral direction of the cultivation plate 10 and the cultivation chamber 20. In case that the first service groove 51 and the second service groove 52 are respectively formed at two opposite lateral ends of the cultivation plate 10 and the cultivation chamber 20, the external device may reach the cultivation plate and the cultivation chamber while clamping the two opposite sides. On the contrary, in case that the first service groove 51 and the second service groove 52 are formed only at one end of the cultivation plate 10 and one end of the cultivation chamber 20, the external device may reach the cultivation plate 10 and the cultivation chamber 20 in one direction and raise the cultivation plate or perform a preset operation in the cultivation chamber 20. It is noted that the positions at which the first service groove 51 and the second service groove 52 are formed are not limited to the above-mentioned examples.

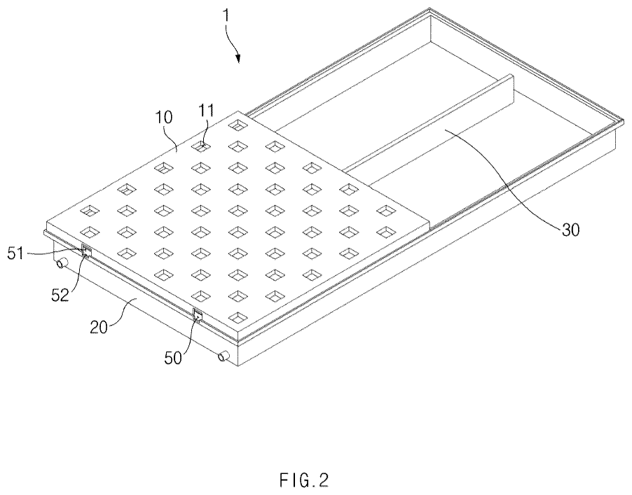

FIG. 2 is a coupled perspective view illustrating the cultivation apparatus 1 according to the embodiment of the present disclosure. With reference to FIG. 2, the cultivation plate 10 may be seated on the cultivation chamber 20. The cultivation plate 10 may cover at least a part of the cultivation opening 21 of the cultivation chamber 20 in the state in which the cultivation plate 10 is seated on the cultivation chamber 20. That is, the cultivation plate 10 may be formed to correspond in size to the cultivation opening 21 of the cultivation chamber 20 and provided to cover the entire cultivation opening 21. Alternatively, the cultivation plate 10 may be formed to be smaller in size than the cultivation opening 21 and cover a part of the cultivation opening 21. In case that the cultivation plate 10 covers only a part of the cultivation chamber 20, the cultivation plate 10 may move (e.g., slide) in the longitudinal direction of the cultivation chamber 20 in a state in which the cultivation plate 10 is not misaligned with the cultivation chamber 20. The cultivation plate 10 may engage with and be coupled to the cultivation chamber 20. The cultivation plate 10 may be positioned in the cultivation opening 21 of the cultivation chamber 20.

The support frame 30 of the cultivation chamber 20 may be in contact with the bottom surface of the cultivation plate 10 and support a load of the cultivation plate 10 from the inside thereof. The support frame 30 may be in contact with the central portion of the cultivation plate 10 and support the cultivation plate 10. Because the above-mentioned configuration is adopted, damage to the cultivation plate 10 may be significantly reduced even in case that a load is applied to the cultivation plate 10 from the outside. The durability of the cultivation plate 10 for withstanding loads of the plants planted in the cultivation holes 11 may be significantly improved.

Service openings 50 may be formed in the cultivation apparatus 1 according to the embodiment in case that the cultivation plate 10 is seated on the cultivation chamber 20.

The service opening 50 may allow the internal space of the cultivation chamber 20 to communicate with the outside. An external mechanical device (e.g., a robot arm) or the like may reach the inside of the cultivation chamber 20 through the service opening 50, thereby significantly improving efficiency of plant cultivation.

The service opening 50 may be defined by the first service groove 51, which is formed in the cultivation plate 10, and the second service groove 52 formed in the cultivation chamber 20. The first service groove 51 and the second service groove 52 may each define a part of the service opening 50. For example, the first service groove 51 and the second service groove 52 may be formed to have the same width. The first service groove 51 and the second service groove 52 may be connected to each other in the state in which the cultivation plate 10 is seated on the cultivation chamber 20.

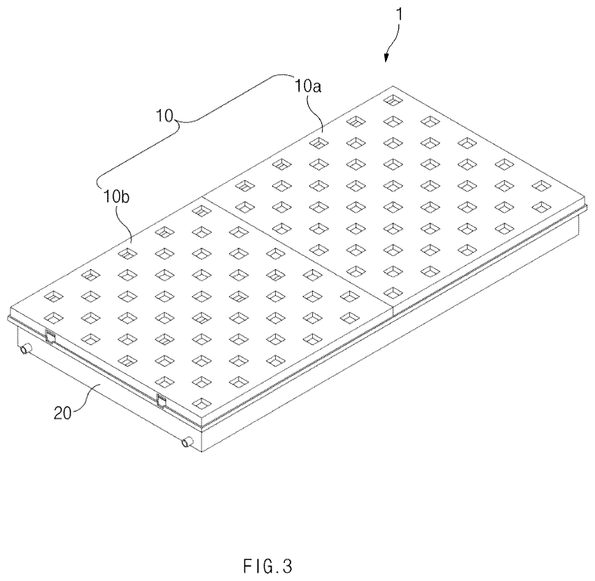

FIG. 3 is a coupled perspective view illustrating the cultivation apparatus 1 according to the embodiment of the present disclosure that is provided with the plurality of cultivation plates 10.

With reference to FIG. 3, the cultivation plate 10 may be provided as the plurality of cultivation plates 10. In this case, the plurality of cultivation plates 10 may be seated on one cultivation chamber 20. For example, the cultivation plates 10 may include a first cultivation plate 10a and a second cultivation plate 10b. The first cultivation plate 10a and the second cultivation plate 10b may be formed to have the same size and shape and disposed to cover the cultivation opening of the cultivation chamber 20 without a gap.

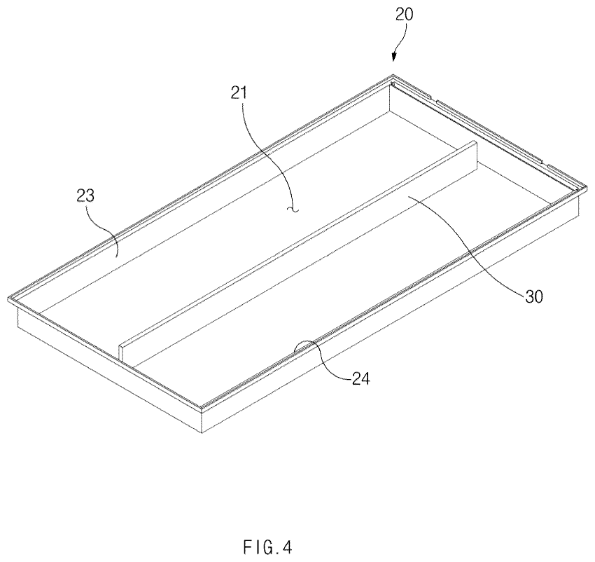

FIG. 4 is a perspective view illustrating the cultivation chamber 20 according to the embodiment of the present disclosure.

With reference to FIG. 4, the cultivation chamber 20 according to the embodiment of the present disclosure may include the support frame 30, a first frame 23, and a second frame 24.

The support frame 30 may protrude from the inner surface of the cultivation chamber 20. The support frame 30 may be provided in the form of a plate at a central portion of the internal space of the cultivation chamber 20 in order to support the central portion of the cultivation plate positioned in the cultivation opening 21. The first frame 23 and the second frame 24 may be positioned on two opposite portions of the cultivation chamber 20. The first frame 23 and the second frame 24 may be parallel to the support frame 30. The first frame 23 and the second frame 24 may support two opposite portions of the support plate positioned in the cultivation opening 21. The first frame 23, the second frame 24, and the support frame 30 may be in contact with the bottom surface of the support plate and support a load of the support plate while dispersing the load of the support plate.

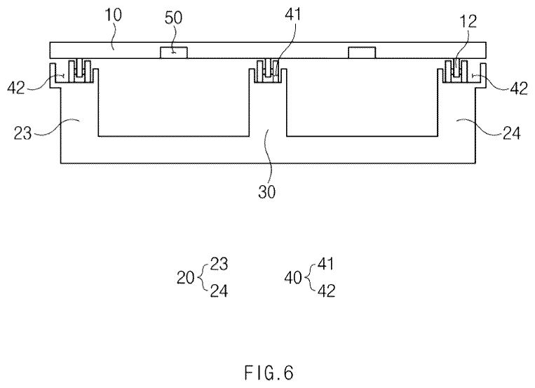

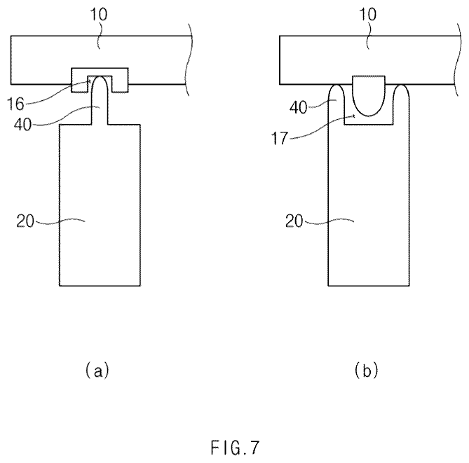

A guide portion, on which the cultivation plate is seated, may be formed at an end of each of the first frame 23, the second frame 24, and the support frame 30 that are in contact with the cultivation plate. The guide portion may align the position of the cultivation plate so that the cultivation plate seated on the cultivation chamber 20 does not deviate from a preset position. The guide portion may include a concave-convex element that may engage with the cultivation plate. A shape and function of the concave-convex element will be described in detail with reference to FIGS. 6 to 7 to be described below.

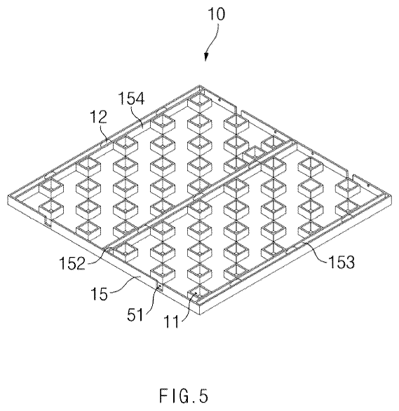

FIG. 5 is a perspective view illustrating the bottom surface of the cultivation plate 10 according to the embodiment of the present disclosure.

With reference to FIG. 5, the cultivation plate 10 according to the embodiment of the present disclosure may include a plate body 15 and coupling elements 12.

The plurality of cultivation holes 11 may be formed in the plate body 15, and plants may be planted in the respective cultivation holes 11. The plate body 15 may include a central frame 152 configured to be in contact with the support frame of the cultivation chamber, and lateral frames 153 and 154 configured to be in contact with the first and second frames of the cultivation chamber. The central frame 152 and the lateral frames 153 and 154 may respectively be in contact with and supported on the support frame and the first and second frames of the cultivation chamber.

The coupling element 12 may be provided on a bottom surface of the plate body 15 so that the coupling element 12 is seated on the concave-convex element of the guide portion of the cultivation chamber. The coupling elements 12 may be formed on the central frame 152 and the lateral frames 153 and 154. The coupling elements 12 may be provided as a plurality of coupling elements 12 formed on the central frame 152 and the lateral frames 153 and 154. The coupling element 12 may be provided in the form of a rollable wheel, a protrusion, or a groove. A shape and function of the coupling element 12 will be described in detail with reference to FIGS. 6 to 7 to be described below.

FIGS. 6 and 7 are schematic views illustrating a shape in which the cultivation plate 10 of the cultivation apparatus according to the embodiment of the present disclosure is seated on the cultivation chamber 20.

With reference to FIG. 6, the cultivation plate 10 may be seated on the cultivation chamber 20 and aligned so as not to deviate from the preset position. Concave-convex elements 42, on which the cultivation plate 10 may be seated, may be formed on the cultivation chamber 20, and a plurality of coupling elements 41, which are seated on the concave-convex elements 42, may be formed on the bottom surface of the cultivation plate 10.

As described above, the concave-convex elements 42 of the cultivation chamber 20 may be formed at the end of the first frame 23, the end of the second frame 24, and the end of the support frame 30. For example, the concave-convex element 42 may be provided in the form of a groove that may engage with the coupling element 41 of the cultivation plate 10. In this case, the grooves may be recessed from the end of the first frame 23, the end of the second frame 24, and the end of the support frame 30.

The coupling element 41 of the cultivation plate seated on the concave-convex element 42 may be provided in the form of a rollable wheel. Because the coupling elements 41 are formed as the wheels, the cultivation plate 10 may move in the longitudinal direction of the cultivation chamber 20 relative to the cultivation chamber 20 in the state in which the cultivation plate 10 is seated on the cultivation chamber 20 without being misaligned. The coupling elements 41, which are provided in the form of the wheels, may be formed on the central frame and the lateral frames of the cultivation plate 10 while corresponding to the respective concave-convex elements 42 formed on the first frame 23, the second frame 24, and the support frame 30 of the cultivation chamber 20.

The external device or the like may reach the internal space of the cultivation chamber 20 through the service opening 50 formed in the cultivation chamber 20 and the cultivation plate 10 that are coupled.

With reference to FIG. 7, the coupling element 41 of the cultivation plate 10 may be provided in the form of a protrusion or a groove instead of a wheel. With reference to FIG. 7A, a concave-convex element 42 of the cultivation chamber 20 may be provided in the form of a guide protrusion protruding from the cultivation chamber 20, and a coupling element 41 of the cultivation plate 10 may be provided in the form of an accommodation groove, into which the guide protrusion is inserted, while corresponding to the concave-convex element 42. On the contrary, with reference to FIG. 7B, a concave-convex element 41 of the cultivation chamber 20 may still be provided in the form of a groove, and a coupling element 41 of the cultivation plate 10 may be provided in the form of a protrusion inserted into the groove.

The shape of the concave-convex element 42 and the shape of the coupling element 41 corresponding to the concave-convex element 42 are not limited to the illustrated configuration. As necessary, the shapes may be variously changed.

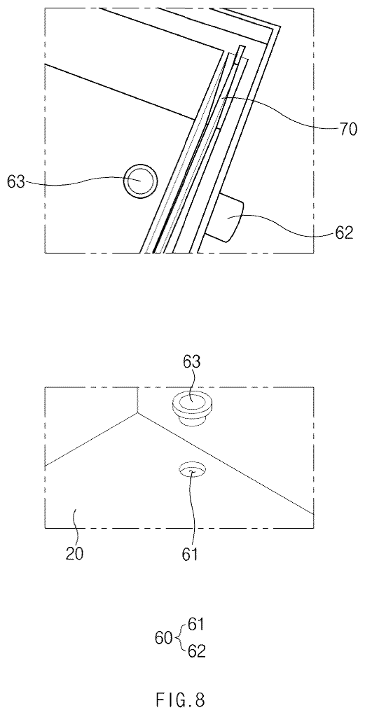

FIGS. 8 to 10 are views illustrating a drainage system of the cultivation apparatus according to the embodiment of the present disclosure.

First, FIG. 8 is a partial stereoscopic view illustrating a discharge part 60 of the cultivation apparatus according to the embodiment of the present disclosure.

With reference to FIG. 8, the cultivation apparatus according to the embodiment of the present disclosure may further include the discharge part 60 provided in the cultivation chamber 20 in order to discharge the nutrient solution accommodated in the cultivation chamber 20.

The discharge part 60 may include a first discharge hole 61 and a second discharge hole 62. With reference to FIG. 8B, the first discharge hole 61 may be formed through the bottom surface of the cultivation chamber 20 and controlled to be opened or closed by a closure 63. With reference to FIG. 8A, the second discharge hole 62 may be formed through a lateral surface of the cultivation chamber 20 adjacent to the bottom surface of the cultivation chamber 20. The second discharge hole 62 may be formed at a preset height from the bottom surface of the cultivation chamber 20.

A control plate 70 may be disposed between the first discharge hole 61 and the second discharge hole 62. The control plate 70 may be disposed between the first discharge hole 61 and the second discharge hole 62 and configured to adjust a level of the nutrient solution in the cultivation chamber 20.

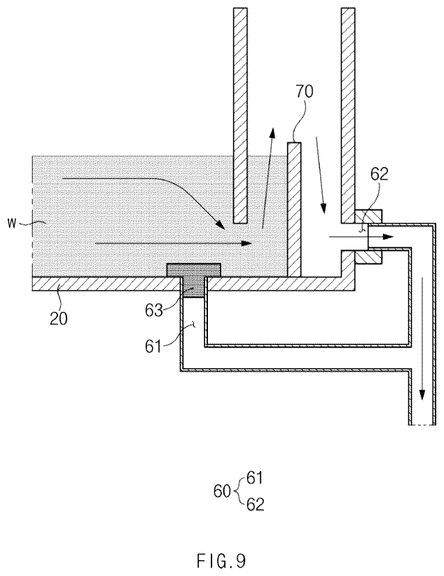

FIG. 9 is a schematic view illustrating a flow of the nutrient solution in the cultivation apparatus according to the embodiment of the present disclosure.

With reference to FIG. 9, a nutrient solution w may be accommodated in the cultivation chamber 20. The nutrient solution w may be discharged to the outside through the first discharge hole 61 formed in the bottom surface of the cultivation chamber 20, and the level of the nutrient solution w may be maintained when the first discharge hole 61 is closed by the closure 63.

The control plate 70 may be disposed between the first discharge hole 61 and the second discharge hole 62. With the configuration of the control plate 70, the level of the nutrient solution w may be controlled in accordance with a height of the control plate 70. Specifically, the level of the nutrient solution w may be identical to the height of the control plate 70 from the bottom surface of the cultivation chamber 20. In case that the level of the nutrient solution w is higher than the height of the control plate 70, the nutrient solution w may flow over the control plate and be discharged to the outside through the second discharge hole 62 formed in the lateral surface of the cultivation chamber 20.

In other words, the level of the nutrient solution may be adjusted in accordance with the height of the control plate 70. The control plate 70 may be separated from the bottom surface of the cultivation chamber 20 and replaced so that the control plate 70 has another height, as necessary.

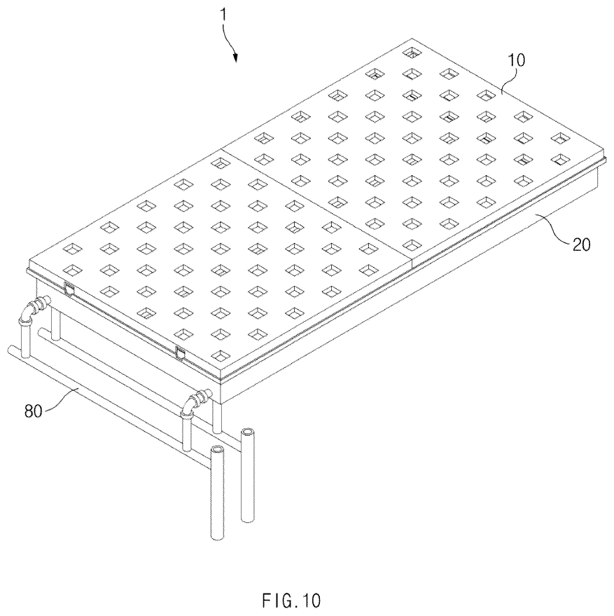

FIG. 10 is a perspective view illustrating a pipe part 80 of the cultivation apparatus 1 according to the embodiment of the present disclosure.

With reference to FIG. 10, the cultivation apparatus 1 according to the embodiment may further include the pipe part 80. The pipe part 80 may communicate with the discharge part of the cultivation apparatus 1 and be configured to transfer the nutrient solution discharged through the discharge part.

While the present disclosure has been described above with reference to the limited exemplary embodiments and the drawings, the above description is simply given for illustratively describing the technical spirit of the present disclosure, and those skilled in the art to which the present disclosure pertains will appreciate that various changes and modifications are possible without departing from the essential characteristic of the present disclosure.

Therefore, the embodiments disclosed in the present disclosure are provided for illustrative purposes only but are not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

1. A cultivation apparatus comprising:
a cultivation plate provided with a plurality of cultivation holes in which plants are planted;
a cultivation chamber configured to accommodate a nutrient solution to be supplied to the plants, the cultivation chamber comprising a cultivation opening in which the cultivation plate is positioned; and
a guide portion formed on the cultivation chamber so that the cultivation plate is seated on the guide portion to align a position of the cultivation plate.

2. The cultivation apparatus of claim 1, wherein the guide portion comprises concave-convex elements on which the cultivation plate is seated.

3. The cultivation apparatus of claim 2, wherein the cultivation chamber further comprises:
a chamber body; and
a support frame protruding from an inner surface of the chamber body and configured to be in contact with the cultivation plate and support the cultivation plate from the inside thereof.

4. The cultivation apparatus of claim 2, wherein the cultivation plate comprises:
a plate body having the cultivation holes; and
coupling elements formed on a bottom surface of the plate body and configured to be seated on the concave-convex elements.

5. The cultivation apparatus of claim 3, wherein the concave-convex elements comprise:
a first concave-convex element provided on the support frame so that a central portion of the cultivation plate is seated on the first concave-convex element; and
second concave-convex elements provided on the chamber body so that two opposite portions of the cultivation plate are seated on the second concave-convex elements.

6. The cultivation apparatus of claim 4, wherein the concave-convex element is provided in the form of a groove that engages with the coupling element of the cultivation plate.

7. The cultivation apparatus of claim 6, wherein the coupling element comprises a wheel placed in the groove so that the plate body is movable relative to the cultivation chamber.

8. The cultivation apparatus of claim 4, wherein the concave-convex element comprises a guide protrusion protruding from the cultivation chamber, and the coupling element comprises an accommodation groove into which the guide protrusion is inserted.

9. The cultivation apparatus of claim 1, further comprising:
a service opening defined by the cultivation plate and the cultivation chamber.

10. The cultivation apparatus of claim 9, further comprising:
a first service groove recessed from an end of the cultivation plate; and
a second service groove recessed from an upper end of the cultivation chamber at which the cultivation opening is formed, the second service groove being configured to define the service opening together with the first service groove when the cultivation plate covers the cultivation opening.

11. The cultivation apparatus of claim 1, further comprising:
a discharge part provided in the cultivation chamber and configured to discharge the nutrient solution accommodated in the cultivation chamber.

12. The cultivation apparatus of claim 11, wherein the discharge part comprises a first discharge hole formed through a bottom surface of the cultivation chamber.

13. The cultivation apparatus of claim 12, wherein the discharge part further comprises a second discharge hole formed through a lateral surface of the cultivation chamber adjacent to the bottom surface.

14. The cultivation apparatus of claim 13, further comprising:
a control plate separably coupled to the bottom surface of the cultivation chamber and configured to adjust a level of the nutrient solution.

15. The cultivation apparatus of claim 14, wherein the control plate is disposed between the first discharge hole and the second discharge hole.
